(19) United States
(12) Patent Application Publication
(10) Pub. No.: US 2022/0111797 A1
(43) Pub. Date: Apr. 14, 2022

(54) ATTACHABLE VEHICLE STORAGE SYSTEM

(71) Applicant: Dennis Plaksin, Margate, FL (US)

(72) Inventor: Dennis Plaksin, Margate, FL (US)

(21) Appl. No.: 17/067,138

(22) Filed: Oct. 9, 2020

(51) Int. Cl. B60R 9/06

(52) U.S. Cl. CPC B60R 9/065

(57) ABSTRACT

A vehicle storage system adapted to removably attach to the rear surface of a vehicle, in particular a Jeep or SUV back-door surface. The present invention includes a lid that lowers to a horizontal position to provide access to the interior of the vehicle storage system. The vehicle storage system may be used for any type of equipment, tools, or other matters. Also, the interior may be retrofit with special entertainment features such as an enclosed screen or a television for viewing purposes; further audio systems may be installed. The lid reclines to a vertical position and may be used for other aspects of entertainment enjoyment.

### BACKGROUND OF THE INVENTION

### Field of Invention

The present invention relates to an attachable tailgate storage system that attaches to the tailgate of a truck, jeep, trailer or other vehicle for additional storage space for said user.

### Description of Related Art

Many truck and Jeep enthusiasts enjoy vehicles for purposes beyond traditional commuting which normally includes recreational activities. Further, these enthusiasts normally retrofit their trucks and/or Jeeps with additional custom features, which includes special bumper systems, custom wheels, custom doors, windows, and/or additional storage systems. Additional storage systems may be convenient to store additional materials or necessary equipment when going off road with a truck or a Jeep. As a result, many of these enthusiasts look for ways to have additional storage area that can provide additional space for the user. Further, it would be advantageous that such a storage space would be easily assembled onto the truck or Jeep in the tailgate area. This space is usually readily available for additional or customized components.

### BRIEF DESCRIPTION OF FIGURES

FIG. 1 shows a front view of a vehicle storage system according to the present invention.

FIG. 2 shows a first side perspective view of the vehicle storage system according to the present invention.

FIG. 3A shows a second perspective view of the vehicle storage system in an open position according to the present invention.

FIG. 3B shows a third perspective view of the vehicle storage system in the open position according to the present invention.

FIG. 4 shows a bottom view of the vehicle storage system according to the present invention.

FIG. 5 shows a focused view of an attachment mechanism according to the present invention.

FIG. 6 shows a view of the vehicle storage system including multimedia equipment.

### DETAILED DESCRIPTION

The present invention relates to a vehicle storage system that removably attaches to the rear surface of a vehicle, in particular a Jeep or SUV back-door surface. The present invention includes a lid that lowers to a horizontal position to provide access to the interior of the vehicle storage system. The vehicle storage system may be used for any type of equipment, tools, or other matters. Also, the interior may be retrofit with special entertainment features such as an enclosed screen or a television for viewing purposes; further audio systems may be installed. The lid reclines to a vertical position and may be used for other aspects of entertainment enjoyment.

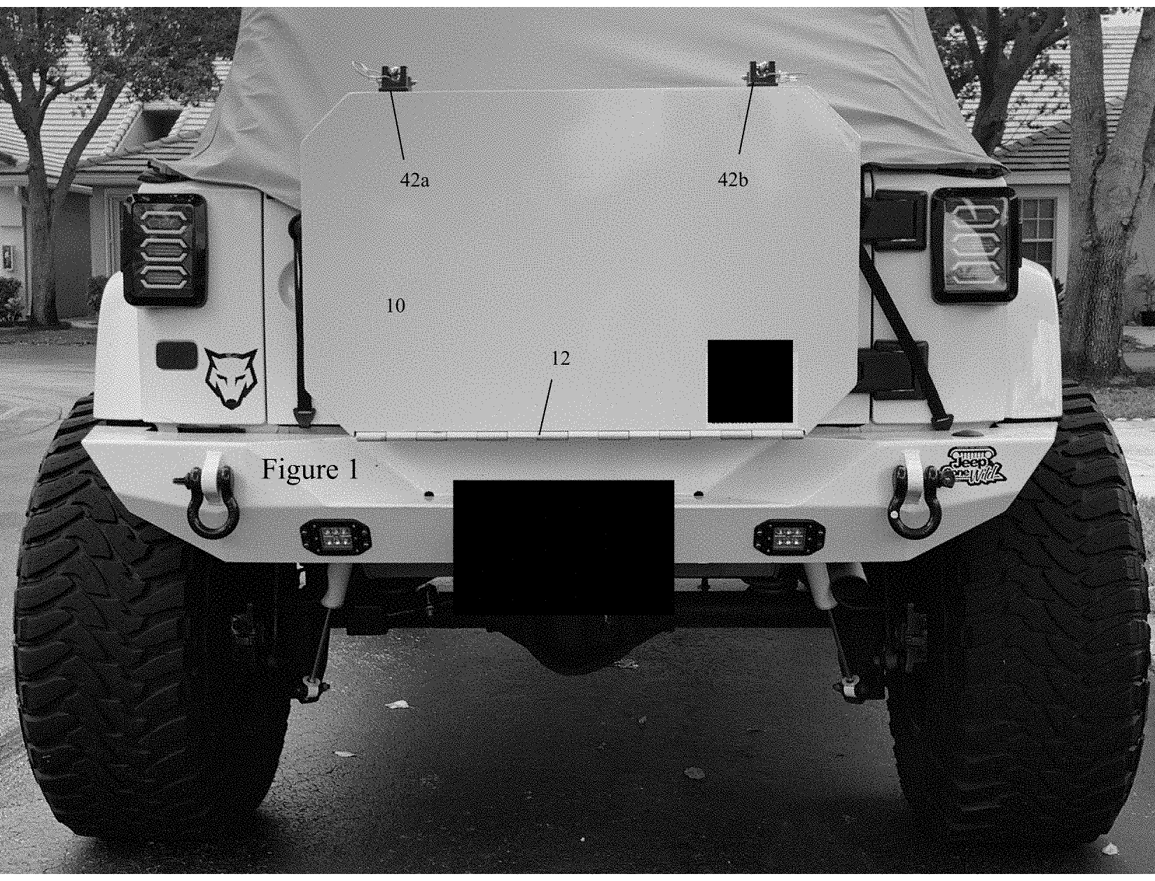

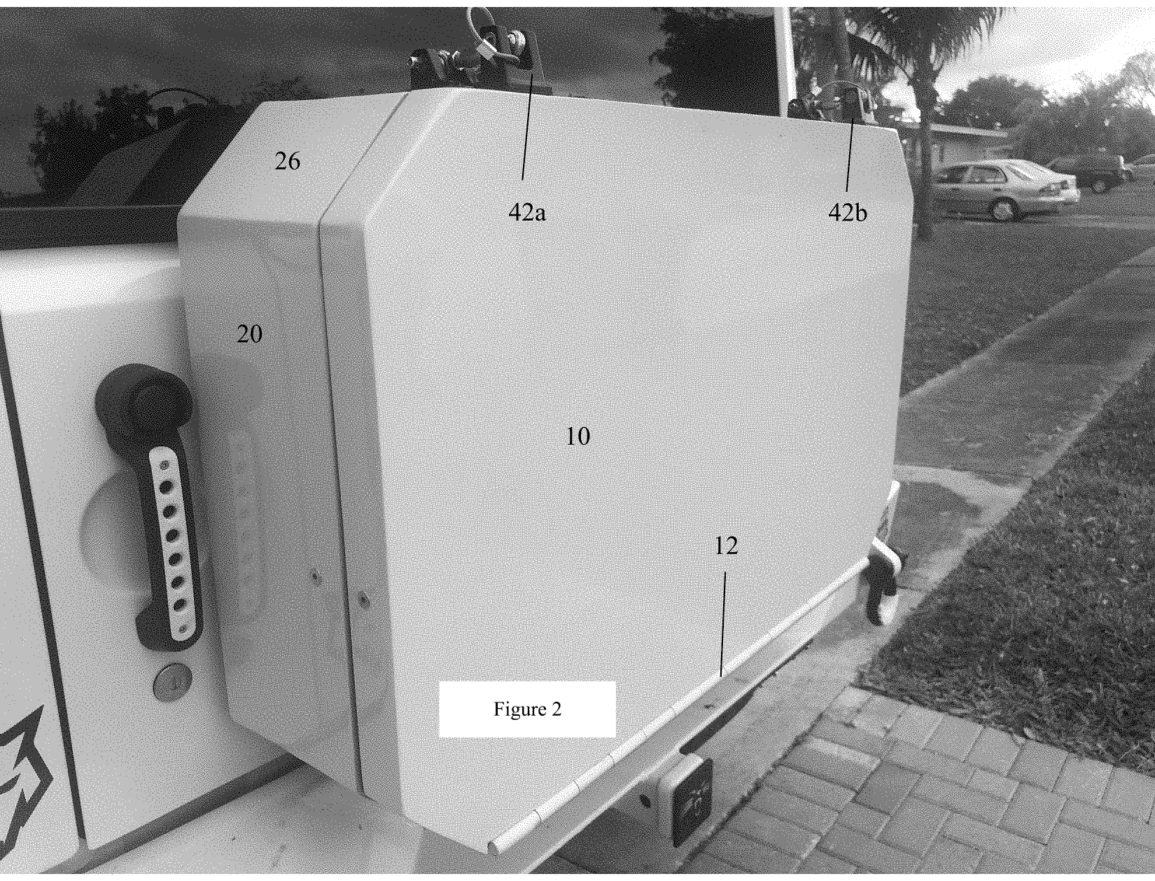

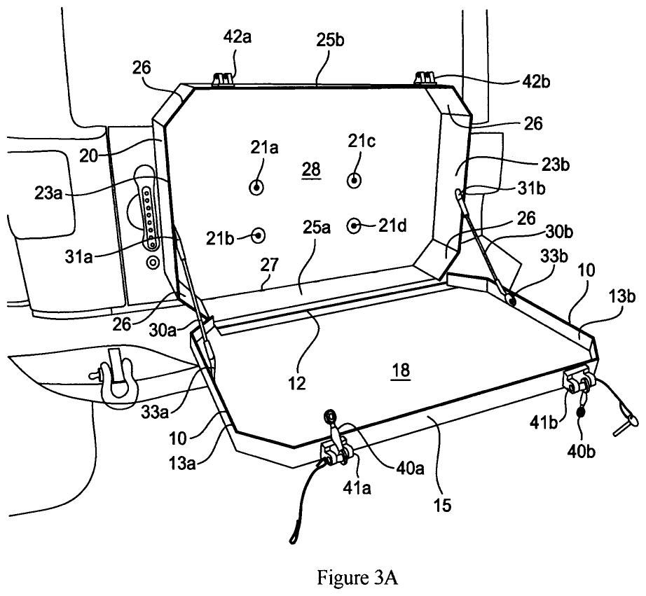

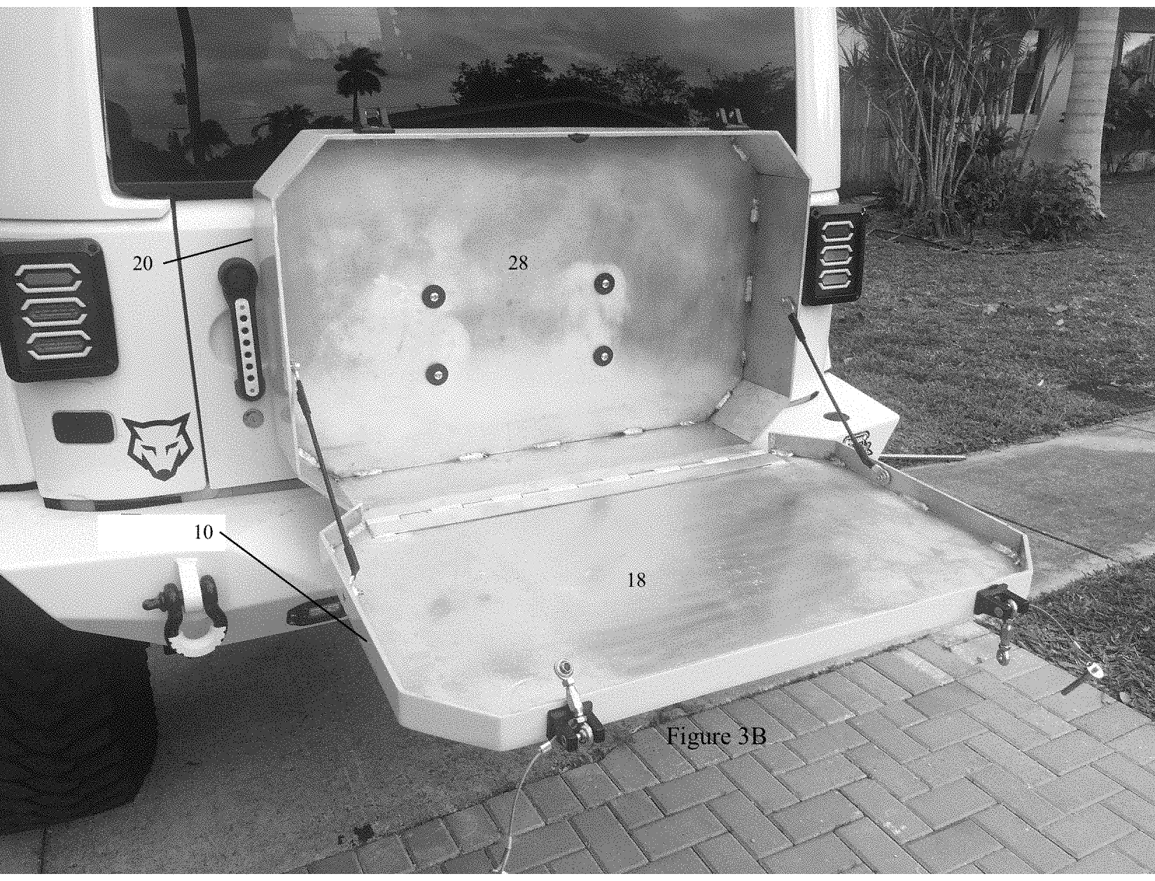

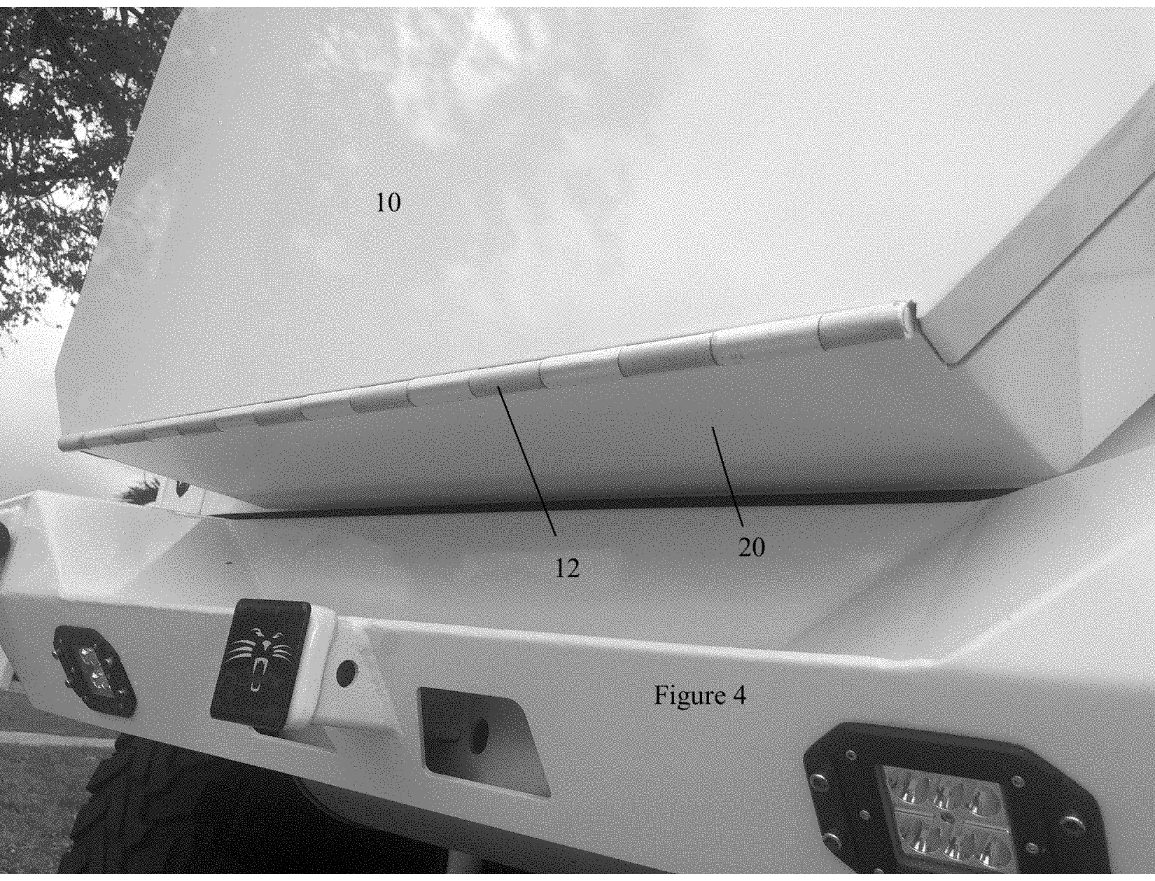

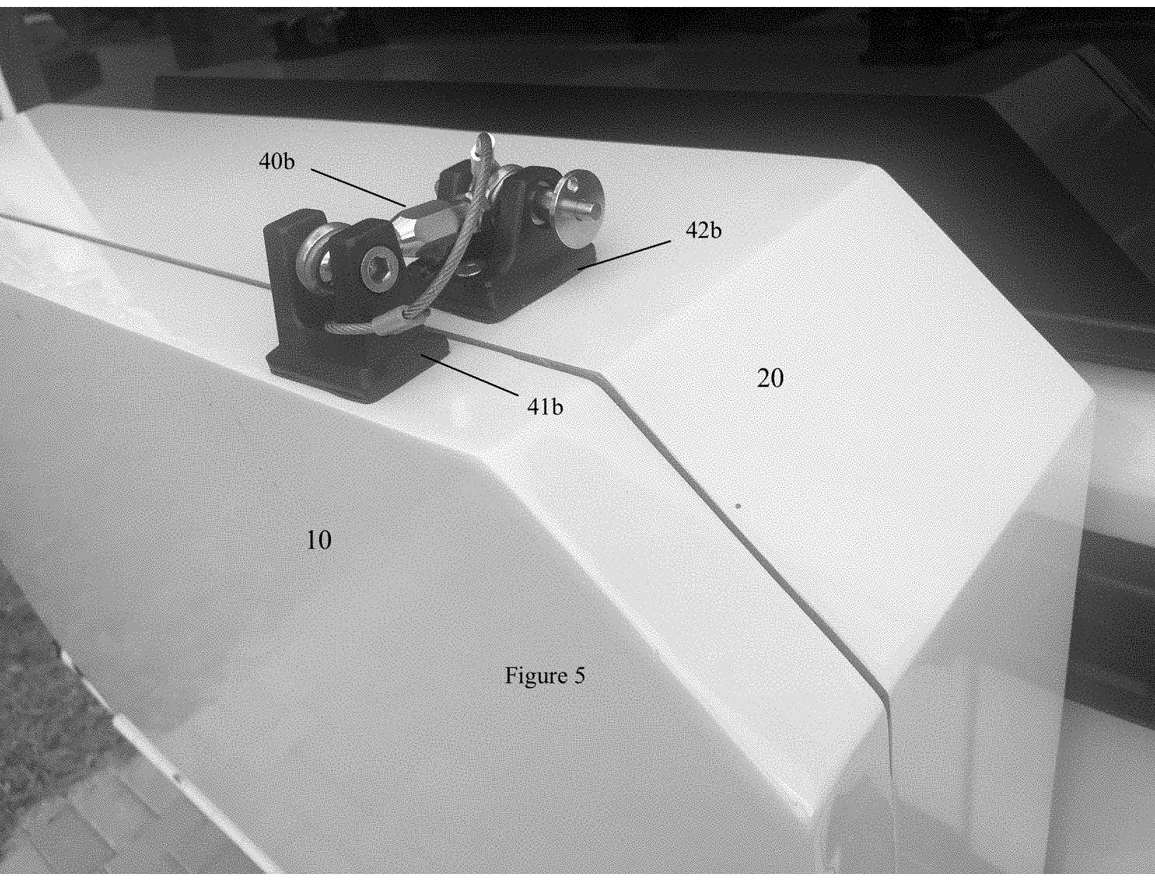

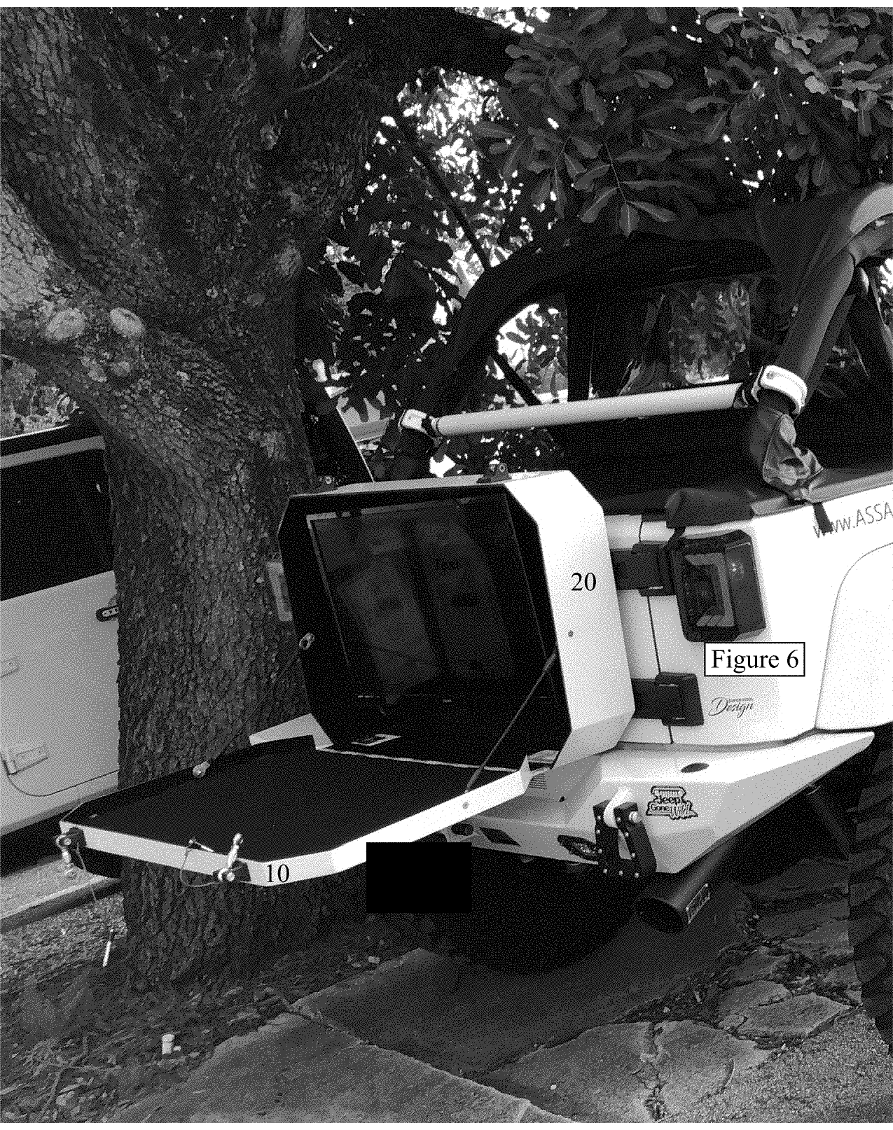

The vehicle storage system 100 is depicted in the FIGS. 1-6 discussed herein. The vehicle storage system 100 includes a base 20 that is removably attached to a rear door or tailgate of a motor vehicle. In particular, the invention is well suited for a Jeep or another sports utility type vehicle. The base 20 as shown receives mounting bolts 21a, 21b, 21c, and 21d, see FIG. 3. The mounting bolts 21a, 21b, 21c, and 21d attach the base 20 onto a vehicle as shown in the figures. These bolts 21a, 21b, 21c, and 21d are inserted in this open position as depicted. A lid 10 is attached to the base 20 through the use of a hinged connector 12. The hinged connector 12 allows for the rotation and movement of the lid 10 from a closed position to an open position. Telescoping mounts 30a, 30b are attached to each respective side of the lid 10 and extend between the interior of the lid 10 on a sidewall 33a, 33b into the sidewalls 23a, 23b of the base 20. The storage system 100 is shown in an open position where the inner surface 18 of the lid 10 is shown and inner surface 28 of the base 20 is shown, see FIG. 3. Latch holder 41a supports a latch 40a therein on one side of the lid 10 on the outer surface of side 15. On the opposing end, a latch holder 41b is shown accommodating a latch 40b. Latches 40a, 40b engaged into the latch holders 42a, 42b on the surface of the sidewall 25b of the base 20.

The base 20 is essentially four-sided with topside 25b, bottom side 25a, and opposing sidewalls 23a, 23b. The base 20 includes chamfered corners 26. Welded connectors secure the outer edge of the base surface 28 to engage the sidewalls and form a rectangular shape. Interior space of the lid 10 is enclosed with sidewalls 13a, 13b. The telescoping mounts 30a, 30b include connectors 31a, 33a to mount 30a; and connectors 31b, 33b for the opposing telescoping mount 30b. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. An attachable storage system for a motor vehicle comprising:
a. a base;
b. sidewalls surrounding base;
c. mounting bolts adapted to secure the base to the motor vehicle;
d. a hinge system on one edge of one sidewall;
e. a lid engaged with the hinge system, where the lid includes a first position and a second position; and
f. attachment latches adapted to secure the lid in the first position, where each attachment latch is permanently affixed to a latch holder on the lid.

2. The attachable storage system according to claim 1, where the first position is closed and the second position is open.

3. (canceled)

4. The attachable storage system according to claim 1, further including at least one receiving latch holder on the base, where each receiving latch holder is adapted to receive one of the attachment latches to place the storage system in a closed position.

5. The attachable storage system according to claim 1, where the hinge system enables the movement the lid between the first position and the second position.

6. The attachable storage system according to claim 1, where the lid includes telescoping mounts extending between the lid and the base.

7. The attachable storage system according to claim 6, where the telescoping mounts include a connector at each end thereof.
